(19) United States
(12) Patent Application Publication
(10) Pub. No.: US 2010/0187129 A1
(43) Pub. Date: Jul. 29, 2010

(54) METHOD FOR PRODUCING ELECTROLYZED WATER

(75) Inventor: YOICHI SANO, KANAGAWA-KEN (JP)

Correspondence Address: ECOLAB USA INC., MAIL STOP ESC-F7, 655 LONE OAK DRIVE, EAGAN, MN, 55121, US

(73) Assignee: ECOLAB, INC., ST. PAUL, MN (US)

(21) Appl. No.: 12/695,535

(22) Filed: Jan. 28, 2010

Related U.S. Application Data
(63) Continuation of application No. 12/082,816, filed on Apr. 14, 2008, now abandoned.
Application No. 12/082,816 is a continuation of application No. 10/629,165, filed on Jul. 29, 2003, now abandoned.

(30) Foreign Application Priority Data
Jul. 31, 2002 (JP) 2002-223208

(51) Int. Cl. C02F 1/461; C25B 1/10

(52) U.S. Cl. 205/748; 205/746; 205/755

(57) ABSTRACT

A method for producing of electrolyzed water involves, using an electrolyzing apparatus for water having a structural feature of dividing an electrolyzer into an anode chamber (D) and a cathode chamber (E) by a diaphragm (1) and arranging an anode plate (3) in the anode chamber and a cathode plate (4) in the cathode chamber and carrying out the electrolysis by filling water to which electrolyte is previously added, wherein the flow rate of water to be provided to the cathode chamber is restricted to 40 mL/min. per 1 A (ampere) of loading electric current or less, and softening previously the water provided to the cathode chamber (10) alone. It is possible to divide the electrolyzer into three chambers by 2 diaphragms, filling an aqueous solution of electrolysis in the center chamber and to provide the electrolysis by electrophoresis.

### CROSS-REFERENCE TO RELATED APPLICATIONS

This application is a continuation of U.S. Ser. No. 12/082,816 filed Apr. 14, 2008 which is a continuation application of U.S. Ser. No. 10/629,165, filed Jul. 29, 2003, which claims priority under 35 USC 119 based on Japanese Application No. 2002-223208 filed Jul. 31, 2002, herein incorporated by reference in their entirety.

### FIELD OF THE INVENTION

The present invention relates to a method for producing acidic electrolyzed water and alkaline electrolyzed water by the electrolysis of water.

### DESCRIPTION OF THE PRIOR ART

The production of acidic electrolyzed water and alkaline electrolyzed water by the electrolysis of water in which chlorine electrolyte has been added is well-known. The acidic electrolyzed water has a range of pH from 2.0 to 3.5 and has a strong sterilizing effect against a colon bacillus, various germs and bacterium so that it recently has started to be used broadly in the medical field, agricultural field, farming field and other fields. While, since the alkaline electrolyzed water has a range of pH from 10.5 to 12.0 and is strongly alkaline, it is well-known that the alkaline electrolyzed water has a weak sterilizing effect and at the same time shows strong detergency against stain-containing oils and proteins. Therefore, the new applications of the alkaline electrolyzed water as the wash water for vegetables, fruits, dairy products and marine products, and further for mechanical parts or electronic materials, have gradually been developed.

To produce the acidic electrolyzed water and alkaline electrolyzed water by electrolysis of water, for example, a method of using an electrolyzing apparatus having a structural feature of dividing a chamber into an anode chamber and a cathode chamber by a diaphragm and arranging an anode plate in the anode chamber and a cathode plate in the cathode chamber and carrying out the electrolysis by filling the apparatus with water to which electrolyte has previously been added can be mentioned. Further, as another example, a method of using an electrolyzing apparatus having a structural feature to divide a chamber into an anode chamber, an intermediate chamber and a cathode chamber by two diaphragms and introducing high concentrated electrolyte into the intermediate chamber, while, introducing water into the anode chamber and the cathode chamber and then carrying out electrolysis can be mentioned. These methods have been practically used.

In these methods, the scale stuck to the cathode plate or the generation of sludge precipitation in the alkaline electrolyzed water are pointed out as problems. Namely, the hardness components such as calcium or magnesium contained in water stick to the cathode plate as scale which causes serious problems such as an increase in the electrical resistance of the electrodes, the loading of the diaphragm or the obstruction of water flow. Up to the present time, the phenomenon of the scale sticking to the cathode has been considered as an unavoidable phenomenon. As a countermeasure to avoid the sticking of the scale, a method of removing the hardness components contained in the water by means of a water softener, washing the scale stuck to the cathode by an acid or releasing the scale by reversing the polarity of the electrodes has been practiced. However, the practical carrying out of these countermeasures are not advantageous from the viewpoints of cost or being troublesome.

### THE OBJECT OF THE INVENTION

The present invention has been arrived at in view of the above-mentioned circumstances and the object of the present invention is to provide a method for water electrolysis that can avoid the sticking of scale to the cathode and generation of sludge precipitation in the alkaline water during the production of acidic electrolyzed water and alkaline electrolyzed water by an easy way.

### DISCLOSURE OF THE INVENTION

The inventors of the present invention, have continued an eager investigation to accomplish the above mentioned object and have found that the sticking of scale to the cathode plate can be effectively avoided by combining two different technologies that strictly restrict the water flow rate to the cathode chamber with regard to the electric current to the cathode plate and a water softening treatment applied only to the water which is supplied to the cathode chamber, while producing acidic electrolyzed water in the anode chamber and alkaline electrolyzed water in the cathode chamber, and accomplished the present invention.

That is, the present invention is a method for producing electrolyzed water comprising, using a water-electrolyzing apparatus having a structural feature which divides an electrolyzer into an anode chamber and a cathode chamber by a diaphragm and arranging an anode plate in the anode chamber and a cathode plate in the cathode chamber and carrying out the electrolysis by filling the electrolysis with water to which electrolyte has previously been added, wherein the flow rate of water to be provided to the cathode chamber is restricted to 40 mL (milliliter)/min. per 1 A (one ampere) of loading electric current, or less, and previously softening the water provided to the cathode chamber.

Further, the present invention is a method for producing electrolyzed water comprising, using a water-electrolyzing apparatus having a structural feature to divide an electrolyzer into an anode chamber, an intermediate chamber and a cathode chamber by two diaphragms and arranging an anode plate in the anode chamber, a cathode plate in the cathode chamber and containing an electrolyte solution in the intermediate chamber, providing water to the anode chamber and cathode chamber of said water-electrolyzing apparatus, and generating acidic water in the anode chamber and alkaline water in the cathode chamber by loading electric current so as to electrolyze the water in the presence of electrolyte supplied by means of electrophoresis from the intermediate chamber, wherein the flow rate of water to be provided to the cathode chamber is restricted to 40 mL/min. per 1 A (one ampere) of loading electric current, or less, and previously softening the water provided to the cathode chamber. Desirably, the above-mentioned water softening treatment is carried out by passing the water through the water softening apparatus in which cationic exchange resin is filled.

Furthermore, the present invention is a method for producing electrolyzed water, wherein the flow rate of the water to be provided to the anode chamber is restricted to 40 mL/min. per 1 A (one ampere) of loading electric current, or less. Furthermore, the present invention is a method for producing electrolyzed water, wherein the water for dilution is mixed with the electrolyzed water produced in said anode chamber to prepare acidic electrolyzed water having a pH from 2.0 to 4.0 and the water for dilution is mixed with the electrolyzed water produced in said cathode chamber so as to prepare alkaline electrolyzed water having a pH from 10 to 13.

### BRIEF ILLUSTRATION OF THE DRAWINGS

FIG. 1 shows the cross sectional view of one example of the water-electrolyzing apparatus used for the method of the present invention.

FIG. 2 shows the cross-sectional view of another example of the water-electrolyzing apparatus used for the method of the present invention.

FIG. 3 shows the cross-sectional view of another example of the water-electrolyzing apparatus used for the method of the present invention.

In the drawings the numbers are: 1 and 2, diaphragm; 3 and 4, electrode plate; 5 and 9, water; A, B and C, wall of electrolyzer; D, anode chamber; E, cathode chamber; F, intermediate chamber; G and H, groove for water flow.

### DETAILED DESCRIPTION OF THE INVENTION

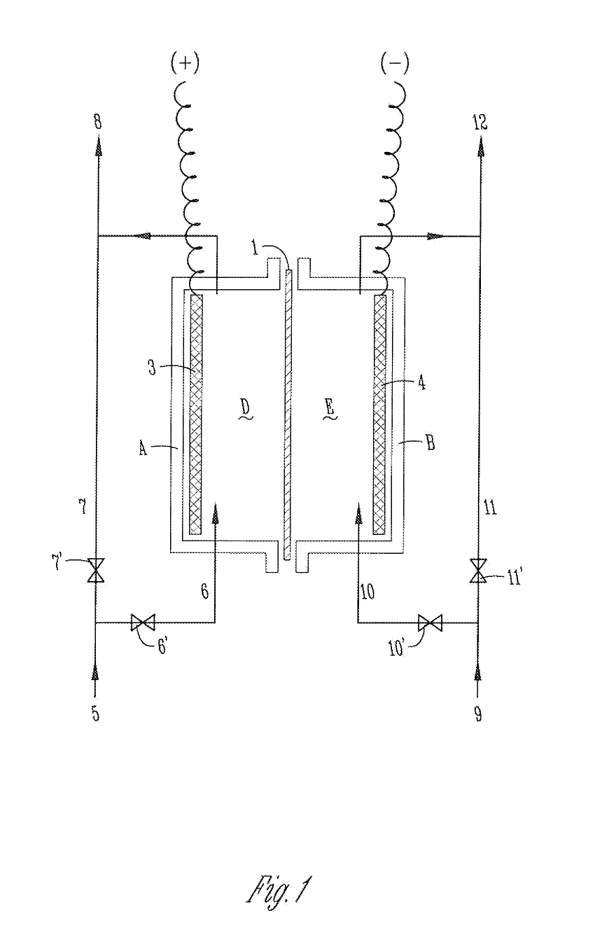

FIG. 1 is a drawing showing a cross-sectional view of one example of a water-electrolyzing apparatus used for the method of the present invention. That is, FIG. 1 is the cross-sectional view of a water-electrolyzing apparatus provided with an electrolyzer divided into an anode chamber and a cathode chamber by one diaphragm and arranged with an anode plate into the anode chamber and a cathode plate into the cathode chamber. (A) and (B) respectively are the walls of the electrolyzer. This electrolyzer is divided into the anode chamber (D) and the cathode chamber (E). (3) and (4) are the electrode plates, and electrode (3) is used as an anode plate and electrode (4) is used as a cathode plate. 6′, 7′, 10′ and 11′ are valves for adjusting the flow rate of the water. The method for producing anionic electrolyzed water and cationic electrolyzed water by the electrolytic treatment of water will be illustrated using the water electrolyzing apparatus providing with the electrolyzer of FIG. 1. The water (5) provided to an anode side is divided into water to be electrolyzed (6) and water not to be electrolyzed (7). To the water to be electrolyzed (6), a small amount of electrolyte is added and introduced to the anode chamber (D). This water to be electrolyzed (6) is electrolyzed in the anode chamber (D) and becomes the acidic electrolyzed water. The obtained acidic electrolyzed water can be used as is, or can be joined with the water not to be electrolyzed (7) and diluted to the desired pH (for example, pH2.0-4.0) to be used as the acidic electrolyzed water (8). In the meanwhile, the water provided to the cathode side (9) is divided into the water to be electrolyzed (10) and the water not to be electrolyzed (11). To the water to be electrolyzed (10), a small amount of electrolyte is added and provided to the anode chamber (E). This water to be electrolyzed (10) is electrolyzed in the cathode chamber and becomes alkaline electrolyzed water. The obtained alkaline electrolyzed water can be used as is, or can be joined with the water not to be electrolyzed (11) and diluted to the desired pH (for example, pH10.0-13.0) to be used as the alkaline electrolyzed water (12).

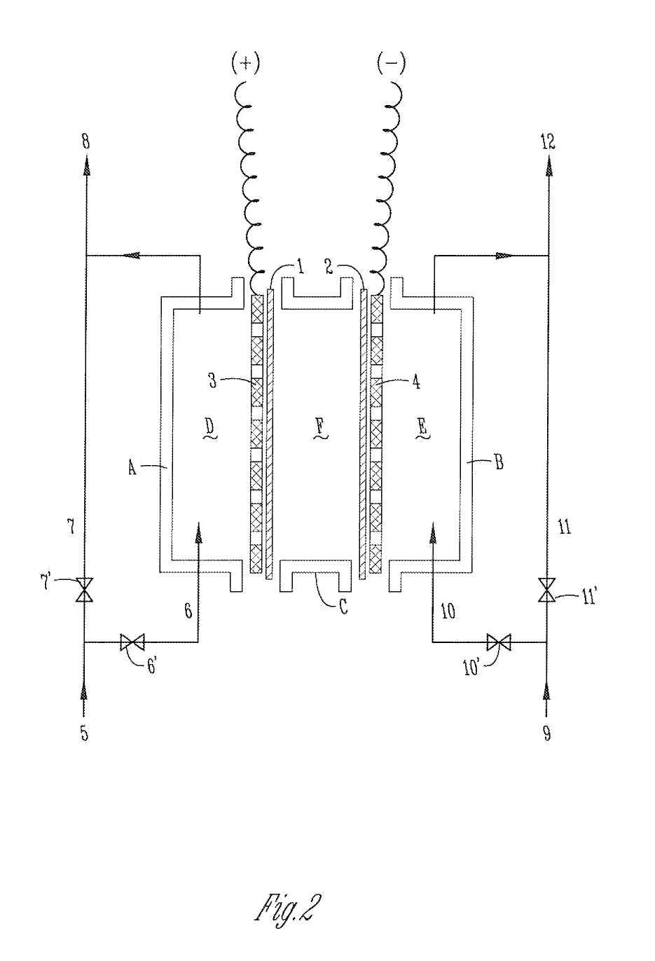

FIG. 2 shows the cross-sectional view of a water electrolyzing apparatus providing with an electrolyzer having arranged therein an anode chamber and a cathode chamber separated by two diaphragms, used in the present invention. (A), (B) and (C) are respectively indicating a wall of the electrolyzer. This electrolyzer is divided into an anode chamber (D), an intermediate chamber (F) and a cathode chamber (E) by two diaphragms (1) and (2). While (3) and (4) are electrode plates, and the electrode plate (3) is the anode plate and the electrode plate (4) is the cathode plate. The electrode plate (3) and the diaphragm (1), and the electrode plate (4) and the diaphragm (2) can be separated or can be contacted. FIG. 2 is the case that the electrode plates and the diaphragms are tightly contacted. As mentioned later, in the case when the electrode plates and the diaphragms are contacted, it is desirable to use an electrode plate that has holes and an electrically non-conductive material is put in between said electrode plates and said diaphragms or to use an electrode whose face is coated by an electrically non-conductive material. In the intermediate chamber (F), electrolyte aqueous solution of high concentration is filled. Ordinarily, an aqueous solution of sodium chloride or potassium chloride of over than 10% concentration is used. Further, said aqueous solution can be provided into the intermediate chamber (F) from the separated tank for electrolyte aqueous solution using a pump. The concentration of the electrolyte can be higher with the limit being not to obstruct the fluidity of the aqueous solution. Further, 6′, 7′, 10′ and 11′ are the valves to adjust the amount of individual water flows to the anode and cathode chambers and diluting water of acid and alkaline products.

The method for producing acidic electrolyzed water and alkaline electrolyzed water by electrolyzing of water will be illustrated more in detail according to the electrolyzing apparatus of water utilizing the electrolyzer of FIG. 2. The water (5) provided to the anode side is divided into water to be electrolyzed (6) and not to be electrolyzed (7). The water to be electrolyzed (6) is led to the anode chamber (D). To the water to be electrolyzed (6), electrolyte is provided by electrophoresis from the intermediate chamber (F), and the water is electrolyzed and becomes acidic electrolyzed water. The obtained acidic electrolyzed water can be used as is, or can be joined with the water not to be electrolyzed (7) and diluted to the desired pH (for example, pH2.0-4.0) so that it can be used as the acidic electrolyzed water (8). In the meanwhile, the water provided to the cathode side (9) is divided into the water to be electrolyzed (10) and the water not to be electrolyzed (11). The water to be electrolyzed (10) is led to the cathode chamber (E). To the water to be electrolyzed (10), electrolyte is provided by electrophoresis from the intermediate chamber (F), and the water is electrolyzed and becomes alkaline electrolyzed water. The obtained alkaline electrolyzed water can be used as is, or can be joined with the water not to be electrolyzed (11) and diluted to the desired pH (for example, pH10.0-13.0) so that it can be used as the alkaline electrolyzed water (12).

In the present invention, during the electrolysis of water by means of the electrolyzing apparatus of water shown in FIG. 1 or FIG. 2, the water to be provided to the cathode chamber (E) has to satisfy following two points. That is, the first one is to restrict the flow rate of the water to be provided to the anode chamber to 40 mL/min. per 1 A of loading electric current or less. And the second one is that the water to be provided to the cathode chamber is water that has been softened previously. By satisfying said two points, the sticking of scale to the cathode can be effectively avoided and the generation of sludge shape precipitation in the alkaline electrolyzed water can be prevented, further, the blockade trouble by precipitation of a pipe or a tank can be prevented.

Further, in the present invention, regarding the water to be provided to the cathode chamber (E), it is desirable to restrict the providing rate of water to 40 mL/min. per 1 A (ampere) of loading electric current or less and it is also desirable to restrict the providing rate of water to the anode chamber (D) to 40 mL/min. per 1 A (ampere) of loading electric current or less. By restricting the amount of water for electrolysis as above, the transfusing phenomenon of water from the anode to the cathode occurring during the electrolysis can be prevented and can elevate the concentration of free chlorine contained in the acidic electrolyzed water.

The above-mentioned water softening treatment can be conveniently carried out by passing the water through a water softening apparatus in which a cationic exchange resin is filled. For the softening treatment of the water to be provided in the cathode chamber (E) (water 10 to be electrolyzed), it is preferable to arrange a water softening apparatus in which a cationic exchange resin is filled, located in between the valve (10′) and the cathode chamber (E) of the electrolyzer. As a cationic exchange resin, a cationic exchange resin using a copolymer consisting of styrene and divinylbenzene or a copolymer consisting of methacrylic acid and divinylbenzene as a mother resin and introducing an acidic group such as a sulfone group or carboxylic group to said mother resin as the exchanging group is used.

The object of the present invention can be accomplished by softening the water to be provided to the cathode chamber alone, among the whole water to be provided to the electrolyzing apparatus of water. The water to be provided to the cathode chamber to be electrolyzed (10) alone, which is a part of the water to be provided to the electrolyzing apparatus of water, is previously softened by passing the water through a water softening apparatus. In the present invention, since the providing amount of water to be electrolyzed (10) is 40 mL/min. per 1 A of loading electric current or less and is recognized to be small, the size of the water softening apparatus in which the cationic exchange resin is filled can be minimized and the cycle for the washing of the cationic exchange resin can be extended. Therefore, by the present invention, the above-mentioned operations are coupled together and effectively prevent the sticking of scale to the cathode.

For example, to generate 1000 mL of acidic electrolyzed water and alkaline electrolyzed water respectively every minute, it is necessary to provide 2000 mL of water to an electrolyzer every minute. Therefore, in the case of softening all the water provided to the electrolyzer, it is necessary to soften 2000 mL of water every minute. While, in the case of the present invention, the flow rate of water to be provided to the cathode and to be electrolyzed is 40 mL/min. per 1 A of loading electric current or less. This rate is converted to the case that produces 1000 mL of acidic electrolyzed water and alkaline electrolyzed water respectively every minute. Since the electric current value loaded at the electrolysis process is generally approximately 6-10 amperes, the amount of water to be provided to the cathode and to be electrolyzed is 240 mL or less in the case of 6 amperes and 400 mL or less in the case of 10 amperes. That is, in the case of the present invention, the maximum amount of water for softening is 400 mL per minute. This amount is less than ⅕ to 2000 mL/min that is the necessary amount for softening of the conventional type. Therefore, in the present invention, the minimization of the size of a water softening apparatus becomes possible and the cycle for the washing of the cationic exchange resin can be extended.

The electrode and the diaphragm of the electrolyzing apparatus of water used in the present invention will be illustrated. The electrode and the diaphragm can be contacted or can be not contacted. In the case when the electrode and the diaphragm are used in contacted condition, a plate having various holes or a net is desirably used as an electrode. In the case when the electrode and the diaphragm are used with a distance therebetween, it is not necessary to have a hole. As the material of the electrode, for example, a plate of copper, lead, nickel, chrome, titanium, tantalum, gold, platinum, iron oxide, stainless steel, carbon fiber or graphite can be mentioned, in particular, as the material of the anode, a platinum genus metal-plated or baked titanium is desirably used. Further, as the material of the cathode, platinum-plated titanium is desirably used, however, chrome stainless steel (SUS316L) or nickel can be also used.

Still further, when the above-mentioned electrode plate with various holes is used in contact with a diaphragm, it is desirable to use an electrode plate prepared by arranging a sheet shape non-electrically conductive material which has corresponding holes to the electrode plate between each electrode plate and diaphragm, or to use an electrode plate with many holes to the surface which faces the diaphragm being coated by a non-conductive film. As specific examples of the material used for the sheet shape non-electrically conductive material, are synthetic resins such as a fluororesin (registered Trade Mark: Teflon), ABS resin, acrylic resin, epoxy resin, polyurethane resin, polypropylene resin, nylon resin, polyethyleneterephthalate resin, polyamide resin and vinyl chloride resin, or natural rubber or elastomer such as SBR, chloroprene and polybutadiene. These electrode plates are disclosed in Japanese Patent Laid open publication 8-276184. These types of electrode plates are desirable to use because they do not generate electrolysis of water at the surface of the diaphragm side, therefore, the phenomenon of the gases staying between the electrode and diaphragm and obstruction of the flow of electric current can be reduced.

As the diaphragm, a material that has water permeability can be used, for examples, woven cloth or non-woven cloth such as polyvinylfluoride fiber, asbestos, glass wool, polyvinylchloride fiber, polyvinylidenechloride fiber, polyester fiber or aromatic polyamide fiber. As another example, which forms the diaphragm by mixing of woven cloth, non-woven cloth of polyester fiber, nylon fiber or polyethylene fiber as an aggregate, and chlorinated polyethylene, polyvinylchloride or polyvinylidenechloride are used as a film, or a diaphragm prepared with mixing of titanium oxide to said diaphragm can be mentioned. Furthermore, a semi-permeable membrane such as cellophane, cationic ion-exchange membranes or anion-exchange membranes can be used. The electrolysis condition of the present invention is to charge a high load electric current to the small amount of water to be electrolysis so as to generate very strong acidic or alkaline water and generate highly concentrated chlorine gas, it is desirable to select a diaphragm that can endure severe conditions.

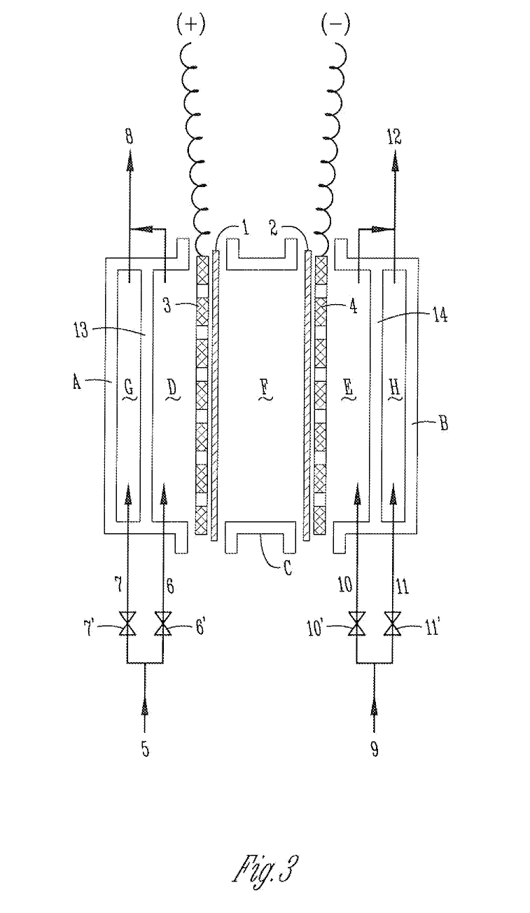

In the electrolyzing apparatus of water of FIG. 2, as shown in FIG. 3, the edge part of the anode chamber (D) is partitioned by a partition board 13 so as to form a groove (G), and the edge part of the cathode chamber (E) is partitioned by a partition board 14 so as to form a groove (H). Water not to be electrolyzed (7) can flow in the groove (G) and water not to be electrolyzed (11) can flow in the groove (H), and the water that flows in groove (G) and groove (H) acts conveniently as the coolant of the electrolyzer.

### Examples

### Example 1

The Example which uses the electrolyzing apparatus of water of FIG. 2 will be substantially illustrated as follows. The size of the electrolyzer is; 15 cm in length, 9 cm in width and 6 cm in thickness. As the electrode plate for anode (3), a platinum/iridium oxide baked titanium plate having many holes and whose actual surface area is 50 cm² is used. While, as the electrode plate for cathode (4), a platinum-plated titanium plate having many holes and whose actual surface area is 50 cm² is used. During the actual use, a sheet of fluororesin (registered Trade Mark: Teflon), which is an electrically non-conductive material, having many holes is coated by a non-conductive film onto the diaphragm side of each electrode plate. As the diaphragm (1) used for the partition of the anode chamber (D) and the intermediate chamber (F), an anionic ion-exchange membrane is used and as the diaphragm (2) used for the partition of the cathode chamber (E) and the intermediate chamber (F), a cationic ion-exchange membrane is used. In the intermediate chamber (F), an aqueous solution of approximately 30% sodium chloride is filled the electrolyte.

As the water (5) to be provided to the anode, city water is used, and is divided into water to be electrolyzed (6) and water not to be electrolyzed (7). The water to be electrolyzed (6) is introduced to the anode chamber (D) and generates acidic electrolyzed water by electrolysis. The obtained acidic electrolyzed water is joined and mixed with not electrolyzed water (7) and adjusted to the desired pH and flows out from the outlet (8), thus the acidic electrolyzed water of a desired pH is obtained. Further, as the water (9) to be provided to the cathode, city water is used, and is divided into the water to be electrolyzed (10) and water not to be electrolyzed (11). The water to be electrolyzed (10) alone is softened by passing through a softening apparatus in which a cationic exchange resin is filled and introduced to the cathode chamber (E) and electrolyzed. Thus the alkaline electrolyzed water is generated. This alkaline electrolyzed water is joined with not electrolyzed water (11) and adjusted to the desired pH and flows out from the outlet (12), thus the alkaline electrolyzed water of a desired pH is obtained.

The direct electric current loaded to the electrode is set to 6.5 amperes and the voltage at the operation is 6.7 volts. The flow rate of water (6) to be electrolyzed and to be introduced to the anode chamber is adjusted to 100 mL per minute, further, the flow rate of water (7) not to be electrolyzed is adjusted to 900 mL per minute, and they are then joined and mixed together at the outlet and 1000 mL per minute of acidic electrolyzed water is obtained. The pH value of the obtained acidic electrolyzed is 2.68, the ORP value is 1130 mV and the measured value of contained free chlorine is 30 ppm. While, the flow rate of water (10) to be electrolyzed and to be introduced to the cathode chamber is adjusted to 100 mL per minute, further, the flow rate of water (11) not to be electrolyzed is adjusted to 900 mL per minute, and they are then joined and mixed together at the outlet and 1000 mL per minute of alkaline electrolyzed water is obtained. The pH value of the obtained alkaline electrolyzed water is 11.54. Maintaining the same operating condition, the electrolysis experiment is continuously carried out for 48 hours, and the sticking of scale to the cathode is not observed at all. Further, the generation of precipitation is not observed in the obtained alkaline electrolyzed water.

### Comparative Example 1

In Example 1, the flow rate of water to be introduced to the cathode chamber (10) is adjusted to 100 mL per minute, while in Comparative Example 1, the flow rate of water to be introduced to the cathode chamber (10) is adjusted to 1000 mL per minute and the flow rate of water (11) not to be electrolyzed is adjusted to 0 mL per minute. Other conditions are set the same as into Example 1 and electrolyzed water is produced.

After starting the electrolysis experiment, the voltage starts to elevate along with the time lapse, and after 48 hours it becomes impossible to continue the electrolysis experiment because of high voltage. The reason for the phenomena can be considered to be as follows. That is, because the hardness component remains in the water (10) to be introduced into the cathode chamber (E), and the remaining hardness component sticks to the cathode plate as scale.

### Comparative Example 2

In Example 1, the water to be electrolyzed (10) is introduced to the cathode chamber (E) after passing through a softening apparatus in which cationic exchange resin is filled and the water is softened, while in the Comparative Example 2, the water to be electrolyzed (10) is introduced into the cathode chamber (E) without softening. Other conditions are set the same as into Example 1 and the electrolyzed water is produced.

5000 mL specimen of the alkaline electrolyzed water is picked out respectively from the alkaline electrolyzed water produced in Example 1 and Comparative Example 2. Each specimen is filtrated using two filtering papers (product of Tokyo Roshi Co., Ltd., Trade Mark “advantec”) and weighted after drying so that the residue can be measured. The results are summarized in Table 1.

TABLE 1

| | weight of filter | weight of filter | weight change | |
|---|---|---|---|---|
| | paper before | paper after | before and after | required time to |
| | filtration (g) | filtration (g) | filtration (g) | filter 5000 mL |
| Example 1 | 1.6529 | 1.7183 | 0.0654 | 50 minutes |
| Co. Example 2 | 1.6238 | 2.0154 | 0.3923 | 6 hours |

It is clearly understood from Table 1 that the amount of precipitate in the alkaline electrolyzed water produced in Comparative Example 2 was greater than the amount of precipitate in the alkaline electrolyzed water produced in Example 1. The filtering time for the alkaline electrolyzed water produced in Comparative Example 2 was remarkably longer than for Example 2, because the filter paper of Example 2 was plugged with the precipitate. After the filtration, a yellowish adhesion was observed on the filter paper. Further, according to the results of Table 1, the amount of scale contained in the alkaline electrolyzed water of the examples was calculated. The amount of scale contained in the alkaline electrolyzed water produced in Example 1 was 13 ppm and that of Comparative Example 2 was 78 ppm.

### EFFECT OF THE INVENTION

In the case of conventional methods for producing electrolyzed water, there are problems of the sticking of scale to a cathode plate during the electrolysis operation and the sludge shape precipitation in the alkaline electrolyzed water. However, according to the present invention, the sticking of scale to the cathode plate and the generation of the sludge shape precipitation in the alkaline electrolyzed water can be effectively avoided, and acidic electrolyzed water and alkaline electrolyzed water can be effectively produced.

1. A method for producing electrolyzed water, comprising:
using an electrolyzing apparatus of water having a structural feature to divide an electrolyzer into an anode chamber and a cathode chamber by a diaphragm, and arranging an anode plate in the anode chamber and a cathode plate in the cathode chamber;
carrying out the electrolysis by filling the cathode chamber with water to which electrolyte is previously added;
wherein the flow rate of water to be provided to the cathode chamber is restricted to 40 mL/min. per 1 A of loading electric current or less;
wherein the water provided to the cathode chamber is previously softened sufficiently to prevent the formation of scale; and
adding non-softened water for dilution with the electrolyzed water produced in the anode and/or cathode chambers to minimize the amount of softened water required to produce electrolyzed water and prepare electrolyzed water sources having desired pH ranges.

2. A method for producing electrolyzed water, comprising:
using an electrolyzing apparatus of water having a structural feature to divide said electrolyzer into an anode chamber, an intermediate chamber and a cathode chamber by two diaphragms, and arranging an anode plate in the anode chamber, and a cathode plate in the cathode chamber;
providing electrolyte solution in the intermediate chamber;
providing water to the anode chamber and cathode chamber of said electrolyzing apparatus of water;
generating acidic water in the anode chamber and alkaline water in the cathode chamber by loading electric current so as to make electrolysis of the water under the presence of electrolyte supplied by means of electrophoresis from the intermediate chamber;
wherein the flow rate of water to be provided to the cathode chamber is restricted to 40 mL/min. per 1 A of loading electric current or less;
wherein the water provided to the cathode chamber is previously softened sufficiently to prevent the formation of scale; and
adding non-softened water for dilution with the electrolyzed water produced in the anode and/or cathode chambers to minimize the amount of softened water required to produce electrolyzed water and prepare electrolyzed water sources having desired pH ranges.

3. The method for producing electrolyzed water of claim 1, wherein the water softening treatment is carried out by passing the water through a water softening apparatus in which cationic exchange resin is filled up.

4. The method for producing electrolyzed water according to claim 1, wherein the flow rate of water to be provided to the anode chamber is restricted to 40 mL/min. per 1 A of loading electric current or less.

5. A method for producing electrolyzed water, comprising:
sufficiently softening water to prevent scale formation prior to adding water to a cathode chamber,
wherein non-softened water for dilution is mixed with electrolyzed water produced in the anode chamber so as to prepare acidic electrolyzed water having a pH from 2.0 to 4.0 and non-softened water for dilution is mixed with electrolyzed water produced in the cathode chamber so as to prepare alkaline electrolyzed water having a pH from 10.0 to 13.0, to minimize the amount of softened water required to produce electrolyzed water.

6. The method for producing electrolyzed water according to claim 2, wherein the water softening treatment is carried out by passing the water through a water softening apparatus in which cationic exchange resin is filled up.

7. The method for producing of-electrolyzed water according to claim 2, wherein the flow rate of water to be provided to the anode chamber is restricted to 40 mL/min. per 1 A of loading electric current or less.

8. The method for producing electrolyzed water according to claim 2, wherein additional water for dilution is added to the water exiting from the cathode chamber after said exiting water leaves the cathode chamber.

9. The method for producing electrolyzed water according to claim 8, wherein the water for dilution is not purified to remove cations.

10. The method for producing electrolyzed water according to claim 2, wherein additional water for dilution is added to the water exiting from the anode chamber after said exiting water leaves the anode chamber.

11. The method for producing electrolyzed water according to claim 1, wherein additional water for dilution is added to the electrolyzed water exiting from the cathode chamber after said exiting electrolyzed water leaves the cathode chamber.

12. The method for producing electrolyzed water according to claim 11, wherein the water for dilution is not purified to remove cations.

13. The method for producing electrolyzed water according to claim 1, wherein additional water for dilution is added to the water exiting from the anode chamber after said exiting water leaves the anode chamber.

14. The method for producing electrolyzed water according to claim 13, wherein additional water for dilution is mixed with the electrolyzed water produced in the anode chamber, to produce electrolyzed water having a pH from 2.0 to 4.0.

15. The method for producing of electrolyzed water according to claim 10, wherein additional water for dilution is mixed with the electrolyzed water produced in the anode chamber, to produce electrolyzed water having a pH from 2.0 to 4.0.

16. The method for producing electrolyzed water according to claim 11, wherein additional water for dilution that is mixed with the electrolyzed water produced in the cathode chamber produces electrolyzed water having a pH from 10.0 to 13.0.

17. The method for producing electrolyzed water according to claim 8, wherein additional water for dilution that is mixed with the electrolyzed water produced in the cathode chamber produces electrolyzed water having a pH from 10.0 to 13.0.

18. The method of claim 5, wherein the water for dilution from at least one of said chambers comprises a sufficient amount of diluting fluid to partially neutralize the pH of said electrolyzed effluent.

19. The method of claim 18, wherein the partially neutralized pH obtained is sufficient to increase the stability of the electrolyzed solution during storage.

20. (canceled)
